(19) United States
(12) Patent Application Publication
(10) Pub. No.: US 2012/0120066 A1
(43) Pub. Date: May 17, 2012

(54) INSTRUCTION ACCEPTING APPARATUS, INSTRUCTION ACCEPTING METHOD, AND RECORDING MEDIUM

(75) Inventor: Takashi HIROTA, Osaka (JP)

(73) Assignee: SHARP KABUSHIKI KAISHA, Osaka (JP)

(21) Appl. No.: 13/296,608

(22) Filed: Nov. 15, 2011

(30) Foreign Application Priority Data
Nov. 17, 2010 (JP) 2010-256920

(51) Int. Cl. G06T 15/00

(52) U.S. Cl. 345/419

(57) ABSTRACT

When an instruction is accepted from a user using a instruction acceptance image which is a stereoscopic image, a plurality of instruction acceptance images are displayed transparently or semi-transparently one on top of the other. Thus, many soft keys of the instruction acceptance images are listed simultaneously, and an instruction is accepted from a user via the displayed instruction acceptance images.

### CROSS-REFERENCE TO RELATED APPLICATIONS

This Nonprovisional application claims priority under 35 U.S.C. §119(a) on Patent Application No. 2010-256920 filed in Japan on Nov. 17. 2010, the entire contents of which are hereby incorporated by reference.

### BACKGROUND

1. Technical Field

The present invention relates to an instruction accepting apparatus, an instruction accepting method, and a recording medium in which a computer program is recorded, for accepting an instruction via an instruction acceptance image for accepting an instruction.

2. Description of Related art

In recent years, various interfaces for improving a user's operationality of an electrical device have been proposed in accordance with the development of the scientific technology.

For example, Japanese Patent Application Laid-Open No. 7-5978 (1995) discloses an input apparatus which displays virtual images of a calculator, a remote controller, etc. on a display section, detects positions of operation button images in these virtual images and a position of a user's fingertip, and judges whether or not the operation button is operated based on a detection result.

Moreover, Japanese Patent Application Laid-Open No. 2000-184475 discloses a remote control apparatus into which remote control devices for a plurality of electronic devices are put together, and the contents of the operation manual are displayed on the remote control apparatus, and thereby a user can easily grasp functions of the electronic devices and control them remotely.

### SUMMARY

On the other hand, due to functional diversification of the recent electric device, operation buttons corresponding to the functions therefor have been increased, thereby operation methods for the recent electronic devices have been also complicated. Therefore, there is a problem in which a user has to look for the operation button with difficulty while switching a plurality of menu screens repeatedly, in order to perform an operation concerning the intended function. However, such a problem cannot be solved using the input apparatus disclosed in Japanese Patent Application Laid-Open No. 7-5978 (1995) and the remote control apparatus disclosed in Japanese Patent Application Laid-Open No. 2000-184475.

The present invention has been made with the aim of solving the above problems. And it is an object of the present invention to provide an instruction accepting apparatus, an instruction accepting method, and a recording medium in which a computer program is recorded, for enabling vision through of a instruction acceptance image which is stereoscopic image and displaying a plurality of the instruction acceptance images one on top of the other, in the instruction accepting apparatus for accepting an instruction using the instruction acceptance image, and thereby allowing for the simultaneous listing of many soft keys (operation buttons) and the visual recognition of the soft keys at a time by a user.

The instruction accepting apparatus according to the present invention is an instruction accepting apparatus for accepting an instruction using an instruction acceptance image which is a stereoscopic image, comprising a display control section for enabling a plurality of the instruction acceptance images to see through one another and displaying them one on top of the other.

In the present invention, the display control section enables vision through of the instruction acceptance image which is stereoscopic image, and displays a plurality of the instruction acceptance images one on top of the other, and an instruction is accepted from a user using the plurality of instruction acceptance images displayed in this manner.

The instruction accepting apparatus according to the present invention is characterized by further comprising: a body position detecting section for detecting a position of a predetermined body part of a user; and an instruction accepting section for accepting an instruction concerning any one of the instruction acceptance images, based on a detection result of the body position detecting section.

In the present invention, the body position detecting section detects a position of a predetermined body part of a user, and the instruction accepting section accepts an instruction concerning any one of the plurality of instruction acceptance images, based on a detection result of the body position detecting section.

The instruction accepting apparatus according to the present invention is characterized in that the predetermined body part is a head, and the display control section deletes any one of the instruction acceptance images, based on a detected position of a user's head.

In the present invention, the body position detecting section detects a position of a user's head, and the instruction accepting section deletes any one of the plurality of instruction acceptance images, based on a detection result of the body position detecting section.

The instruction accepting apparatus according to the present invention is characterized in that when the instruction accepting section accepts an instruction, an instruction acceptance image other than an instruction acceptance image concerning the instruction is indistinctly displayed.

In the present invention, when the instruction accepting section accepts an instruction, the display control section displays an instruction acceptance image other than an instruction acceptance image concerning the accepted instruction indistinctly.

The instruction accepting method according to the present invention is an instruction accepting method for accepting an instruction using an instruction acceptance image which is a stereoscopic image, with an instruction accepting apparatus comprising a body position detecting section for detecting a position of a predetermined body part of a user, comprising: a displaying step for enabling a plurality of the instruction acceptance images to see through one another and displaying them one on top of the other; and an instruction accepting step for accepting an instruction concerning any one of the instruction acceptance images, based on a detection result of the body position detecting section.

The recording medium according to the present invention is a non-transitory computer-readable recording medium in which a computer program is recorded, the computer program causing a computer constituting an instruction accepting apparatus with a body position detecting section for detecting a position of a predetermined body part of a user, to accept an instruction using an instruction acceptance image which is a stereoscopic image, said computer program comprising: a displaying step for causing the computer to enable a plurality of the instruction acceptance images to see through one another and display them one on top of the other; and an instruction accepting step for causing the computer to accept an instruction concerning any one of the instruction acceptance images, based on a detection result of the body position detecting section.

In the present invention, a plurality of instruction acceptance images which are stereoscopic images are displayed one on top of the other in a state where vision through of the instruction acceptance images is enabled. An instruction is accepted from a user via the plurality of instruction acceptance images displayed in this manner.

In the present invention, the above-described computer program is recorded on the recording medium. A computer reads the computer program from the recording medium, and the above-described instruction accepting apparatus and instruction accepting method are realized by the computer.

According to the present invention, since many soft keys can be simultaneously listed in front of a user and a user can recognize the many soft keys at a time visually, the operationality of the apparatus can be improved.

The above and further objects and features will more fully be apparent from the following detailed description with accompanying drawings.

### BRIEF DESCRIPTION OF THE SEVERAL VIEWS OF THE DRAWINGS

FIG. 1 is a functional block diagram showing essential configurations of an instruction accepting apparatus according to Embodiment 1 of the present invention.

FIG. 2 is an explanatory diagram for explaining a visual effect by a difference of z-index values.

FIG. 3 is an explanatory diagram for explaining detection of a position of a user's specific body part by a body position detecting section of the instruction accepting apparatus according to Embodiment 1 of the present invention.

FIG. 4 is an explanatory diagram for explaining acceptance of a user's instruction in the instruction accepting apparatus according to Embodiment 1 of the present invention.

FIG. 5 is an explanatory diagram for explaining view, by a user, of a plurality of window images displayed in the instruction accepting apparatus according to Embodiment 1 of the present invention.

FIG. 6 is a flow chart for explaining acceptance of an instruction from a user in the instruction accepting apparatus according to Embodiment 1 of the present invention.

FIG. 7 is a flow chart showing a response when a user approaches the instruction accepting apparatus according to Embodiment 1 of the present invention.

FIG. 8 is a conceptual diagram conceptually representing an example of a judgment result of a CPU 1 at S203.

FIG. 9 is a functional block diagram showing essential configurations of an instruction accepting apparatus 100 according to Embodiment 2 of the present invention.

### DETAILED DESCRIPTION

The following description will explain an instruction accepting apparatus and an instruction accepting method according to Embodiments of the present invention, based on the drawings in detail.

The instruction accepting apparatus according to the present invention is configured so as to display a window (instruction acceptance image) for accepting an instruction from a user as a stereoscopic image, detect an operation of the user with respect to the window based on a gesture of the user, and accept an instruction of the user.

### Embodiment 1

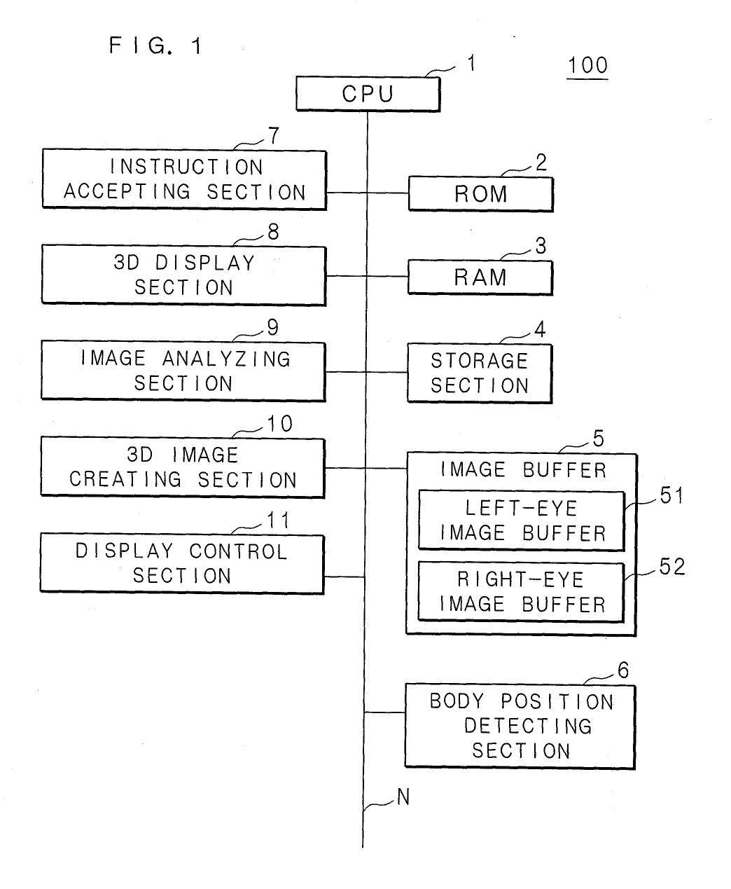

FIG. 1 is a functional block diagram showing essential configurations of an instruction accepting apparatus 100 according to Embodiment 1 of the present invention. The instruction accepting apparatus 100 comprises a CPU 1, a ROM 2, and a RAM 3.

The ROM 2 stores various kinds of control programs in advance, and the RAM 3 is capable of storing data temporarily and allows the data to be read regardless of the order and place they are stored. The RAM 3 stores, for example, a program read from the ROM 2, various kinds of data generated by the execution of the program and the like.

The CPU 1 controls a later-described various hardware devices via a bus N by loading on the RAM 3 the control program stored in the ROM 2 in advance and executing it, and operates the whole apparatus as the instruction accepting apparatus 100 of the present invention.

The instruction accepting apparatus 100 according to Embodiment 1 of the present invention further comprises a storage section 4, an image buffer 5, a body position detecting section 6, an instruction accepting section 7, a 3D display section 8, an image analyzing section 9, a 3D image creating section 10, and a display control section 11.

The storage section 4 stores a window image data with z-index information, in which the z-index information is added to the window image data created in two dimensions. In detail, the window image data with z-index information includes two-dimensional coordinates for constituting a window image (later-described window constitution coordinates) and a z-index value for defining a position in a depth direction with respect to a display screen of the 3D display section 8. That is, since each window includes a plurality of soft keys, the window image data with z-index information includes two-dimensional coordinates for drawing the soft keys and constituting the window, and the z-index value concerning the two-dimensional coordinates.

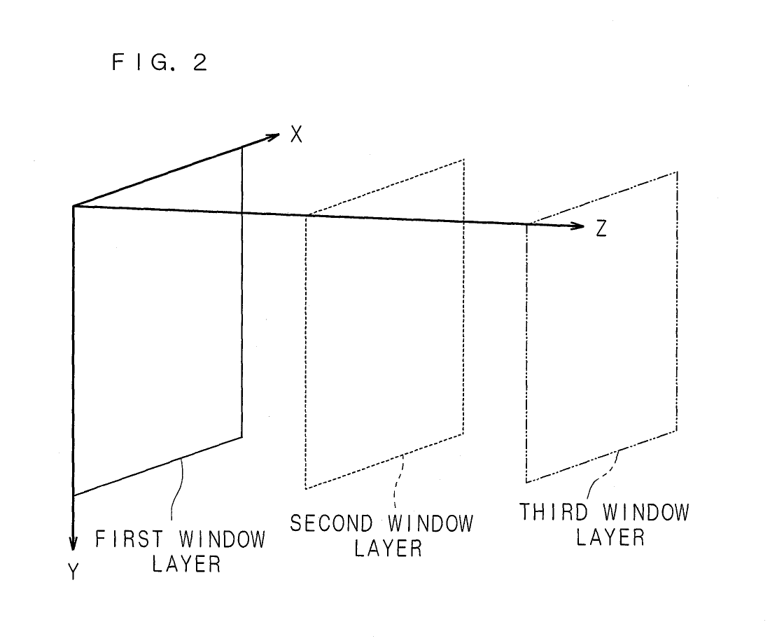

FIG. 2 is an explanatory diagram for explaining a visual effect by a difference of z-index values. Since the z-index values added to the plurality of window images are different from each other, the depth perception is changed when a plurality of window images are displayed on the 3D display section 8. Therefore, as shown in FIG. 2, a first window layer, a second window layer and a third window layer exist in the z axial direction in stages, and relative stereoscopic vision can be acquired.

Moreover, the storage section 4 stores a z-index and depth table in which a plurality of items of depth information representing a distance from the display screen of the 3D display section 8 are associated with the z-index values of a plurality of window image data items with z-index information, respectively. In detail, in the z-index and depth table, the z-index values of the respective windows (or window layers) are respectively associated with a plurality of items of depth information arbitrarily set based on said z-index values. Based on the z-index and depth table, and on two-dimensional coordinates and depth information of a specific body part of a user acquired by the body position detecting section 6 as described later, the instruction accepting section 7 accepts an instruction from a user.

The image analyzing section 9 analyzes whether or not an image (window image data) to be displayed on the 3D display section 8 has z-index information. When the image analyzing section 9 analyzes that the image has z-index information, it detects the z-index value and sends it to the 3D image creating section 10.

The 3D image creating section 10 creates a 3D image of a window to be displayed on the 3D display section 8, based on the z-index information detected by the image analyzing section 9.

Since a left eye and a right eye of a human being are away from each other to some extent, pictures to be viewed by the left eye and the right eye are slightly different from each other, and thereby the human being can feel the image sterically due to an azimuth difference of the left eye and the right eye. This principle is used in the instruction accepting apparatus according to the present invention. That is, the 3D image creating section 10 creates images for left eye and right eye which have an azimuth difference, based on the z-index information detected by the image analyzing section 9. Since a method for creating the images for left eye and right eye is a known technique, a detailed description is omitted here.

The image buffer 5 stores temporarily the image for left eye and the image for right eye of the window created by the 3D image creating section 10. The image buffer 5 has a left-eye image buffer 51 and a right-eye image buffer 52. The left-eye image buffer 51 stores the image for left eye created by the 3D image creating section 10, and the right-eye image buffer 52 stores the image for right eye created by the 3D image creating section 10.

When the display control section 11 causes the 3D display section 8 to display a image for left eye and a image for right eye of a window created by the 3D image creating section 10, it performs a process for stereoscopic vision. In detail, the display control section 11 reads the image for left eye and the image for right eye stored in the left-eye image buffer 51 and the right-eye image buffer 52 respectively, and divides them into rows having a predetermined width in a lateral direction (x axial direction), respectively. Then, the display control section 11 causes the 3D display section 8 to display the rows of the image for left eye and the rows of the image for right eye alternately. Since this process is performed using the known technique, a detailed description is omitted.

Moreover, the display control section 11 causes the 3D display section 8 to display a predetermined window (window layer) indistinctly if necessary. The display control section 11 causes the 3D display section 8 to display the window, for example, so as to be out of focus, that is, have a so-called feathering effect.

The 3D display section 8 comprises a 3D liquid crystal, for example. That is, each row displayed on the 3D display section 8 has an effect such as a display through a polarization glass, the rows created from the image for left eye enter only the left eye and the rows created from the image for right eye enter only the right eye. As a result, the image for left eye and the image for right eye which are displayed on the 3D display section 8 and are slightly different from each other enter the left eye and the right eye, respectively, and a user can see a window image containing the image for left eye and the image for right eye as one stereoscopic image.

The body position detecting section 6 detects a position of a user's specific body part. The body position detecting section 6 comprises an RGB camera for vision, a depth-of-field camera for depth detection using infrared ray, etc., for example.

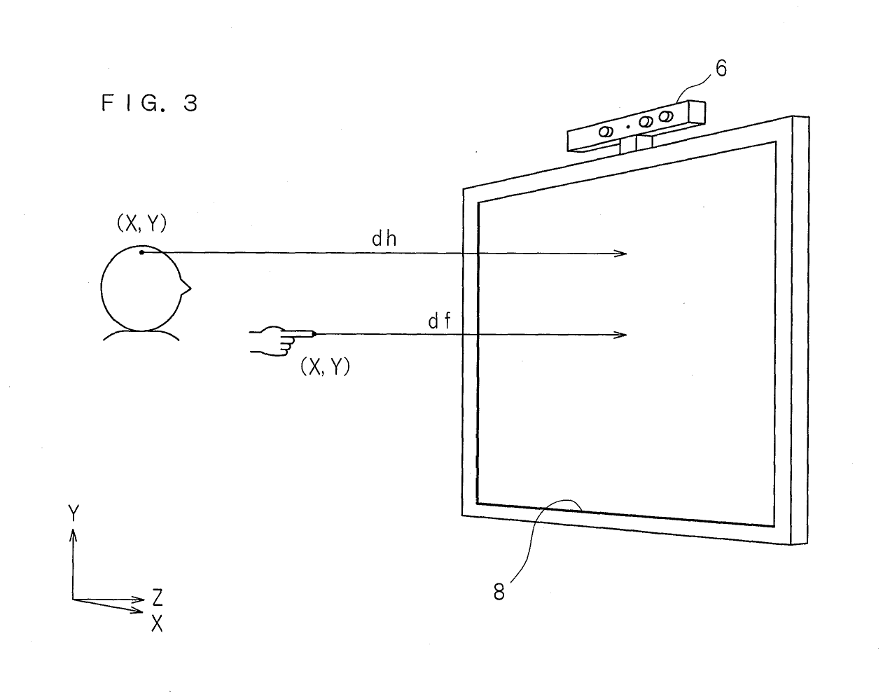

FIG. 3 is an explanatory diagram for explaining detection of a position of a user's specific body part by the body position detecting section 6 of the instruction accepting apparatus 100 according to

Embodiment 1 of the present invention. The body position detecting section 6 picks up an image of a user by the RGB camera, and detects a specific body part (for example, a face, a fingertip, etc.) of the user on the picked up image. The existing technique is used for the detection process. For example, the body position detecting section 6 detects an area approximate to a skin color of a human being from the image picked up by the RGB camera of the body position detecting section 6, and judges whether or not a pattern of a characteristic shape included in a face of a human being, such as eyes, eyebrows and a mouth, is included in the detected area, or whether or not a pattern of a characteristic shape of a hand of a human being is included in the detected area. When the body position detecting section 6 judges that the pattern of the characteristic shape is included, the body position detecting section 6 recognizes the pattern as a head or a hand, and detects a position (for example, two-dimensional coordinates) of the head or a fingertip.

From the image of the user's head and fingertip, for example, detected by the RGB camera, the depth-of-field camera acquires depth information (df) of a user's fingertip, depth information (dh) of a user's head, etc.

The body position detecting section 6 can identify positions of a user's fingertip and head, based on the two-dimensional coordinates of the user's head and hand (fingertip) on the picked up image, detected by the RGB camera, and the depth information (df) of the user's fingertip and the depth information (dh) of the user's head acquired by the depth-of-field camera in this manner.

The instruction accepting section 7 accepts an instruction of a user, based on a detection result of the body position detecting section 6, the z-index and depth table, and two-dimensional coordinates constituting a window image (hereinafter referred to as window constitution coordinates).

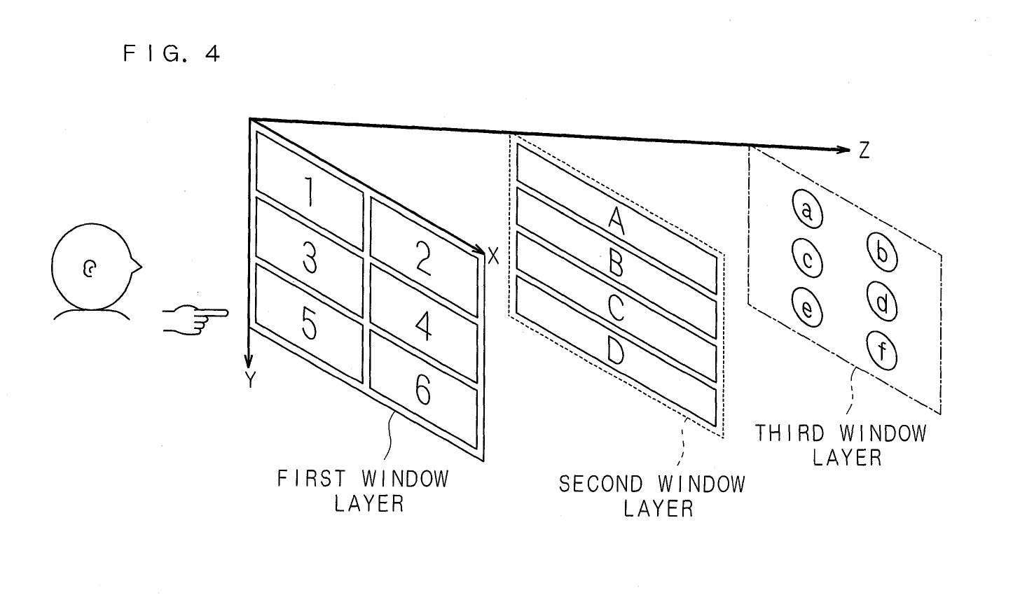

The following description will explain acceptance of a user's instruction by the instruction accepting section 7 in detail. FIG. 4 is an explanatory diagram for explaining acceptance of a user's instruction in the instruction accepting apparatus 100 according to Embodiment 1 of the present invention. In the instruction accepting apparatus 100 according to Embodiment 1 of the present invention, as shown in FIG. 4, z-index values of a plurality of windows to be displayed are changed, and thereby a plurality of window layers are displayed sterically one on top of the other in stages to a user. In this case, a user moves his/her fingertip suitably, for example, and operates a soft key of any one of the window layers, and the body position detecting section 6 detects two-dimensional coordinates and depth information of the fingertip. Then, the CPU 1 acquires a z-index value corresponding to the detected depth information of the fingertip based on the z-index and depth table, and identifies a window layer concerning the acquired z-index value. Moreover, the CPU 1 identifies a soft key having two-dimensional coordinates corresponding to the detected two-dimensional coordinates of the fingertip from the soft keys of the window layer, based on the window constitution coordinates. The instruction accepting section 7 recognizes acceptance of an instruction concerning the identified soft key of window layer, based on an identification result of the CPU 1.

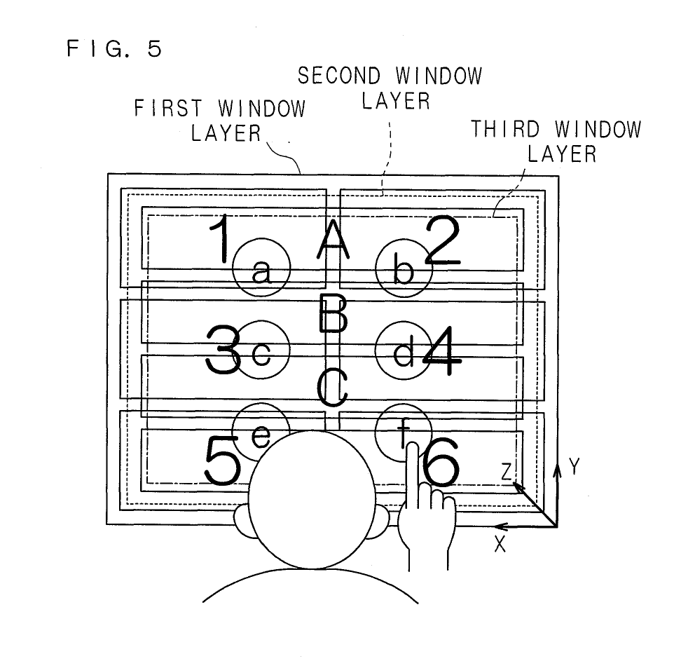

Moreover, in the instruction accepting apparatus 100 according to Embodiment 1 of the present invention, when a plurality of window layers are displayed sterically one on top of the other in stages, each window layer (window) is displayed transparently or semi-transparently, as described above. In detail, each window layer is displayed transparently or semi-transparently except frames and characters constituting the soft keys. FIG. 5 is an explanatory diagram for explaining view, by a user, of a plurality of window images displayed in the instruction accepting apparatus 100 according to Embodiment 1 of the present invention.

As shown in FIG. 5, in the instruction accepting apparatus 100 according to Embodiment 1 of the present invention, since a plurality of window layers are displayed sterically one on top of the other transparently or semi-transparently, a user can visually recognize soft keys of all the window layers at a time. That is, many soft keys can be listed in front of a user, without extending an area (in the x axial direction and the y axial direction shown in the drawing) of each window layer.

Note that the present invention is not limited to the above-described configuration, and it may be configured to change a size and lightness, etc. of each window layer in order to improve depth perception of the window layers.

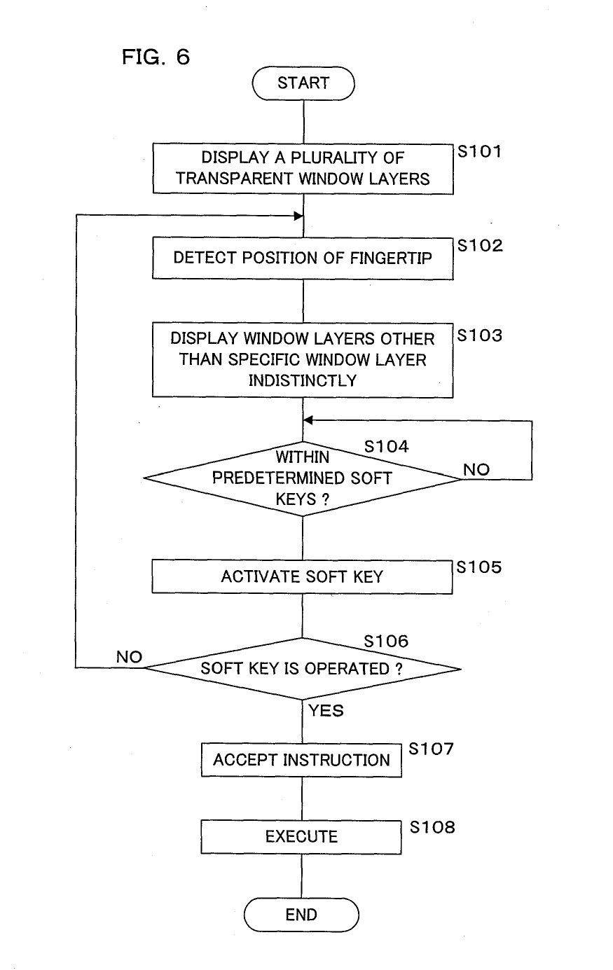

FIG. 6 is a flow chart for explaining acceptance of an instruction from a user in the instruction accepting apparatus 100 according to Embodiment 1 of the present invention.

First, a user suitably operates the instruction accepting apparatus 100 according to Embodiment 1 of the present invention, to give an instruction to display a plurality of window layers (windows). According to the instruction of the user, the display control section 11 causes the 3D display section 8 to display a plurality of transparent window layers sterically one on top of the other (S101). The stereoscopic display of the window layers by the 3D display section 8 according to an instruction of the display control section 11 is performed as described above, and a detailed description is omitted.

Subsequently, the body position detecting section 6 detects a position of a user's fingertip (S102). The body position detecting section 6 acquires two-dimensional coordinates and depth information of the user's fingertip. The detection of a position of a user's fingertip by the body position detecting section 6 is performed as described above, and a detailed description is omitted.

Then, the CPU 1 acquires a z-index value corresponding to the depth information of the fingertip, based on said depth information of the user's fingertip acquired by the body position detecting section 6 and the z-index and depth table stored in the storage section 4, and identifies a window layer concerning the z-index value.

Moreover, the CPU 1 gives an instruction for the display control section 11 to cause the 3D display section 8 to indistinctly display window layers other than the identified window layer (hereinfter referred to as specific window layer). According to the instruction of the CPU 1, the display control section 11 performs the feathering effect for the window layers other than the specific window layer, and causes the 3D display section 8 to display them indistinctly (S103). Therefore, it is possible to cause a user to recognize a notable window layer, and obtain the similar effect as so-called activation.

Subsequently, the CPU 1 judges whether or not the user's fingertip is within predetermined soft keys, based on the two-dimensional coordinates of the user's fingertip acquired by the body position detecting section 6 (S104). In detail, the CPU 1 judges whether or not the two-dimensional coordinates of the user's fingertip exist within an area compartmentalized (drawn) by the two-dimensional coordinates concerning the predetermined soft keys, based on the window constitution coordinates.

When the CPU 1 judges that the user's fingertip does not exist within the predetermined soft keys (S104: NO), it waits until the user's fingertip exists within the predetermined soft keys.

On the other hand, when the CPU 1 judges that the user's fingertip exists within the predetermined soft keys (S104: YES), the display control section 11 activates the soft key (S105), and notifies a user of the notable soft key. For example, the display control section 11 causes the 3D display section 8 to append a color to the notable soft key and display said soft key.

Subsequently, the CPU 1 judges whether or not the soft key is operated (S106). For example, a user presses the soft key with his/her fingertip in order to operate the soft key. At this time, the CPU 1 monitors the user's fingertip via the body position detecting section 6. For example, when the depth information of the user's fingertip changes largely although the two-dimensional coordinates of the fingertip do not change largely by the pressing operation of the user's fingertip, the CPU 1 judges that the soft key is operated.

When the CPU 1 judges that the soft key is not operated for a predetermined period, for example (S106: NO), it returns the process to S102.

On the other hand, when the CPU 1 judges that the soft key is operated (S106: YES), the instruction accepting section 7 recognizes an acceptance of an instruction concerning the soft key (S107).

At this time, the CPU 1 executes the instruction concerning the soft key, accepted via the instruction accepting section 7 (S108).

However, as described above, suppose that a case where when a plurality of window layers are displayed transparently or semi-transparently one on top of the other sterically, a user may approach in order to see nearby a window layer seen in the distance. The following description will explain a response in the instruction accepting apparatus 100 according to Embodiment 1 of the present invention when a user approaches the instruction accepting apparatus 100 in this manner.

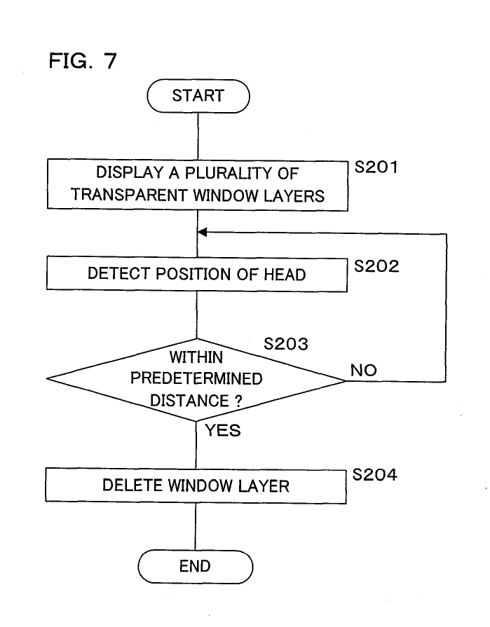

FIG. 7 is a flow chart showing a response when a user approaches the instruction accepting apparatus 100 according to Embodiment 1 of the present invention. For convenience of description, the following description will explain an example in which after a plurality of window layers are displayed (refer to FIG. 4), a user approaches the instruction accepting apparatus 100 in order to see nearby a window layer (for example, the third window layer in FIG. 4) seen in the distance.

First, a user suitably operates the instruction accepting apparatus 100 according to Embodiment 1 of the present invention, to give an instruction to display a plurality of window layers. According to the instruction of the user, the display control section 11 causes the 3D display section 8 to display a plurality of transparent window layers sterically one on top of the other (S201). The stereoscopic display of the window layers by the 3D display section 8 according to the instruction of the display control section 11 is performed as described above, and a detailed description is omitted.

Subsequently, the body position detecting section 6 detects a position of a user's head (S202). The body position detecting section 6 acquires two-dimensional coordinates and depth information of the head of the user. The detection of the position of the head of the user by the body position detecting section 6 is performed as described above, a detailed description is omitted.

Subsequently, the CPU 1 judges whether or not the user is within a predetermined distance from the instruction accepting apparatus 100, based on the depth information of the user's head acquired by the body position detecting section 6 (S203). That is, the depth information acquired by the body position detecting section 6 is changed according to a distance from the instruction accepting apparatus 100. In other words, the depth information represents a distance from the instruction accepting apparatus 100. Therefore, when a threshold value of depth information corresponding to the predetermined distance is set in advance, the CPU 1 can compare the threshold value with the depth information acquired by the body position detecting section 6 and thereby judge whether or not a user is within a predetermined distance.

In more detail, the instruction accepting apparatus 100 according to Embodiment 1 of the present invention is configured so as to use the depth information concerning each window layer written in the z-index and depth table, as the threshold value of depth information. That is, at S203, the CPU 1 compares the depth information of the user's head acquired by the body position detecting section 6 with the depth information concerning each window layer of the z-index and depth table to judge whether or not the user is within the predetermined distance from the instruction accepting apparatus 100.

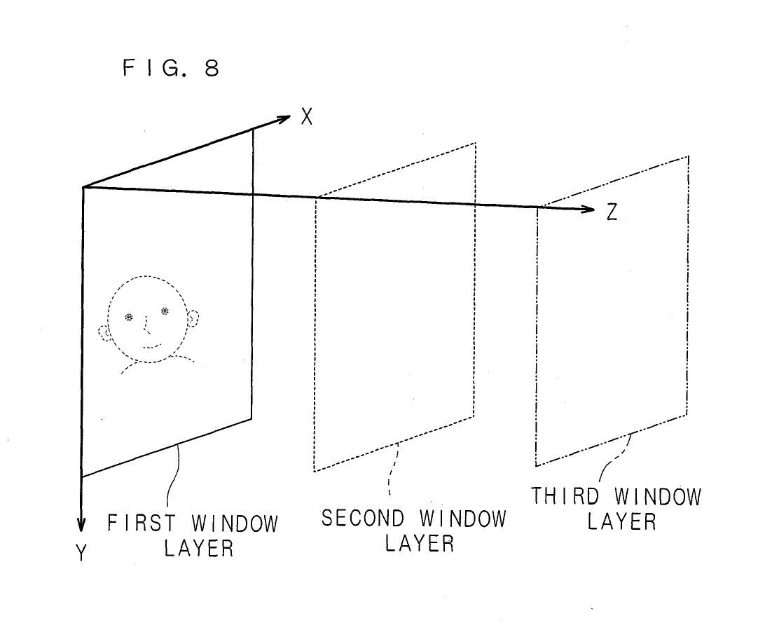

On the other hand, for example, a case arises in which since the user approaches the instruction accepting apparatus 100 in order to see nearby a window layer (for example, the third window layer in FIG. 4) seen in the distance, the CPU 1 judges that the depth information (distance) of the user's head acquired by the body position detecting section 6 is within the depth information (distance) concerning the first window layer (S203: YES). FIG. 8 is a conceptual diagram showing such a case conceptually. If such a judgment result of the CPU 1 is represented virtually, as shown in FIG. 8, it corresponds to a state where a user's head approaches the instruction accepting apparatus 100 closer than the first window layer.

In such a case, the CPU 1 gives an instruction for the display control section 11 to delete the first window layer. According to the instruction of the CPU 1, the display control section 11 deletes the first window layer from the 3D display section 8 (S204).

Note that, when the CPU 1 judges that the depth information (distance) of the user's head acquired by the body position detecting section 6 is within the depth information (distance) concerning the second window layer at S203, the display control section 11 deletes the first window layer and the second window layer from the 3D display section 8.

On the other hand, when the CPU 1 judges that the user is not within the predetermined distance from the instruction accepting apparatus 100 (S203: NO), that is, when the CPU 1 judges that the depth information (distance) of the user's head acquired by the body position detecting section 6 is not within the depth information (distance) concerning any one of the window layers of the z-index and depth table, the CPU 1 returns the process to S202.

The instruction accepting apparatus 100 according to Embodiment 1 of the present invention is not limited to the above-described configuration. For example, it may be configured so as to replace an order (in the z axial direction) of window layers when a predetermined change of two-dimensional coordinates and depth information is detected by a predetermined gesture of a user's head or fingertip.

Moreover, although the above description explains the case in which the body position detecting section 6 comprises the RGB camera for vision, the depth-of-field camera for depth detection using infrared ray, and detects a position of a user's specific body part, the present invention is not limited to this. For example, it may be configured so as to cause a user's specific body part to wear an infrared light emitting element, collect infrared ray from the infrared light emitting element, and detect a position of the user's specific body part.

Furthermore, although the above description explains the case in which a plurality of windows (window layers) are displayed on the 3D display section 8 sterically one on top of the other, the present invention is not limited to this. For example, it may be configured so as to use a so-called HMD (Head Mount Display).

Note that it may be configured so as to use a so-called primitive method, a glasses method of a polarizing filter or a liquid crystal shutter, instead of using the 3D display section 8.

### Embodiment 2

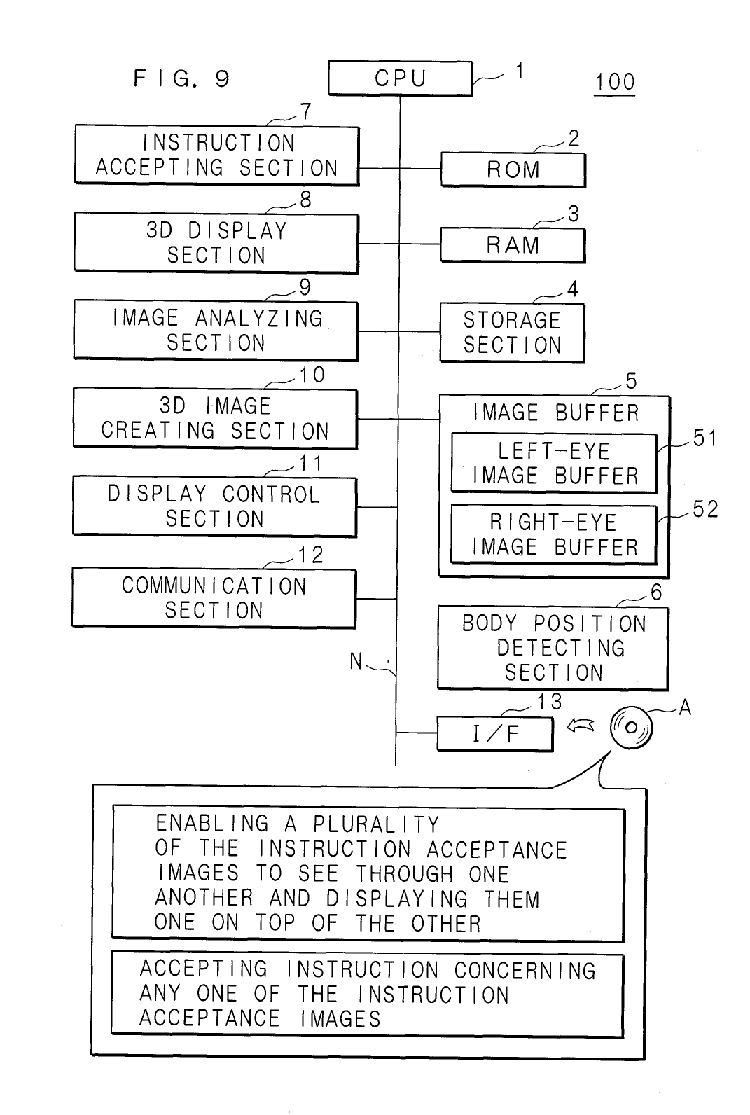

FIG. 9 is a functional block diagram showing essential configurations of an instruction accepting apparatus 100 according to Embodiment 2 of the present invention. The instruction accepting apparatus 100 according to Embodiment 2 is configured so that a computer program for operations is capable of being provided by a removable recording medium A, such as a CD-ROM, through an I/F 13. Moreover, the instruction accepting apparatus 100 according to Embodiment 2 is configured so that the computer program is capable of being downloaded from an external device (not shown) through a communication section 12. The contents will be explained below.

The instruction accepting apparatus 100 according to Embodiment 2 comprises an external (or internal) recording medium reader device (not shown). A removable recording medium A, which records a program for enabling vision through of a plurality of instruction acceptance images which are stereoscopic images, displaying the instruction acceptance images one on top of the other, and accepting an instruction concerning any one of the plurality of instruction acceptance images, is inserted into the recording medium reader device, and, for example, a CPU 1 installs the program in a ROM 2. The program is loaded in a RAM 3 and executed. Consequently, it functions as the instruction accepting apparatus 100 according to Embodiment 1 of the present invention.

The recording medium may be a so-called program media, or a medium carrying program codes in a fixed manner, such as tapes including a magnetic tape and a cassette tape, disks including magnetic disks such as a flexible disk and a hard disk, and optical disks such as a CD-ROM, an MO, an MD, and a DVD, cards such as an IC card (including a memory card) and an optical card, or semiconductor memory such as a mask ROM, an EPROM, and an EEPROM, and a flash ROM.

Or, the recording medium may be a medium carrying program codes in flowing manner like downloading the program codes from a network through the communication section 12. In the case where the program is downloaded from a communication network in such a manner, a program for downloading is stored in the main apparatus in advance, or installed from a different recording medium. Note that the present invention is also implemented in the form of a computer data signal embedded in a carrier wave in which the program codes are embodied by an electronic transfer.

The same parts as in Embodiment 1 are designated with the same reference numbers, and detailed explanations thereof will be omitted.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An instruction accepting apparatus for accepting an instruction using an instruction acceptance image which is a stereoscopic image, comprising
a display control section for enabling a plurality of the instruction acceptance images to see through one another and displaying them one on top of the other.

2. The instruction accepting apparatus according to claim 1, further comprising:
a body position detecting section for detecting a position of a predetermined body part of a user; and
an instruction accepting section for accepting an instruction concerning any one of the instruction acceptance images, based on a detection result of the body position detecting section.

3. The instruction accepting apparatus according to claim 2, wherein
the predetermined body part is a head, and
the display control section deletes any one of the instruction acceptance images, based on a detected position of a user's head.

4. The instruction accepting apparatus according to claim 2, wherein
when the instruction accepting section accepts an instruction, an instruction acceptance image other than an instruction acceptance image concerning said instruction is indistinctly displayed.

5. An instruction accepting method for accepting an instruction using an instruction acceptance image which is a stereoscopic image, with an instruction accepting apparatus comprising a body position detecting section for detecting a position of a predetermined body part of a user, comprising:
a displaying step for enabling a plurality of the instruction acceptance images to see through one another and displaying them one on top of the other; and
an instruction accepting step for accepting an instruction concerning any one of the instruction acceptance images, based on a detection result of the body position detecting section.

6. A non-transitory computer-readable recording medium in which a computer program is recorded, the computer program causing a computer constituting an instruction accepting apparatus with a body position detecting section for detecting a position of a predetermined body part of a user, to accept an instruction using an instruction acceptance image which is a stereoscopic image, said computer program comprising:
a displaying step for causing the computer to enable a plurality of the instruction acceptance images to see through one another and display them one on top of the other: and
an instruction accepting step for causing the computer to accept an instruction concerning any one of the instruction acceptance images, based on a detection result of the body position detecting section.

7. An instruction accepting apparatus for accepting an instruction using an instruction acceptance image which is a stereoscopic image, comprising
display means for enabling a plurality of the instruction acceptance images to see through one another and displaying them one on top of the other.

8. The instruction accepting apparatus according to claim 7, further comprising:
detecting means for detecting a position of a predetermined body part of a user; and
instruction accepting means for accepting an instruction concerning any one of the instruction acceptance images, based on a detection result of the detecting means.

9. The instruction accepting apparatus according to claim 8, wherein
the predetermined body part is a head, and
the display means deletes any one of the instruction acceptance images, based on a detected position of a user's head.

10. The instruction accepting apparatus according to claim 8, wherein
when the instruction accepting means accepts an instruction, an instruction acceptance image other than an instruction acceptance image concerning said instruction is indistinctly displayed.
